(19) United States
(12) Patent Application Publication
(10) Pub. No.: US 2006/0206598 A1
(43) Pub. Date: Sep. 14, 2006

(54) Extended domain name method, apparatus, and system

(76) Inventors: James V. Borzilleri, Las Vegas, NV (US); Rodney Dean Palmer, Sandy, UT (US)

Correspondence Address: UTAH VALLEY PATENT SERVICES, LLC, 846 S. 1350 E., PROVO, UT, 84606, US

(21) Appl. No.: 11/433,373

(22) Filed: May 12, 2006

Related U.S. Application Data
(62) Division of application No. 10/301,231, filed on Nov. 21, 2002.

(51) Int. Cl. G06F 15/177

(52) U.S. Cl. 709/220

(57) ABSTRACT

An extended DNS server that supports non-standard domain naming includes an update module, a query module, and a domain name database. Client computers are converted to extended clients capable of supporting extended domain naming by changing a DNS server IP address to reference an extended DNS server. The conversion program also supports maintenance operations related to domain naming such as providing status information related to the DNS servers, updating an executable, updating a DNS address, and restoring the DNS IP address to a previous value. The present invention facilitates incrementally upgrading an intra-network or inter-network to with extended name serving capabilities.

### BACKGROUND OF THE INVENTION

1. Related Applications

This application claims priority to, and is a divisional of, U.S. patent application Ser. No. 10/301,231 entitled “EXTENDED DOMAIN NAME METHOD, APPARATUS, AND SYSTEM”, and filed on 21 Nov. 2002 for James V. Borzilleri and Rodney Dean Palmer, which application is incorporated herein by reference.

2. The Field of the Invention

The invention relates to methods, means, and systems for domain name serving. Specifically, the invention relates to methods, means, and systems for conducting extended domain name serving.

3. The Relevant Art

Domain naming is a method of referencing computer resources such as web pages using alphanumeric names instead of IP addresses. Domain names are typically structured with two or more levels of names separated by a delimiter such as a period. The highest level, which is listed last, is typically known as the top-level domain name. For example, the domain name www.uspto.gov comprises a top-level domain name of “gov”, a secondary domain name of “uspto” and a tertiary domain name of “www”.

The process of converting a domain name to an IP address is known as domain name serving or domain name mapping. To reduce the complexity of domain name serving, the domain names that are registered and supported are typically restricted to a finite list of standard top-level domain names such as “corn” for businesses, “edu” for educational institutions, and “gov” for government institutions.

To properly manage domain naming and domain name mapping, selected servers within an intra-network or inter-network are designated as DNS (Domain Name System) servers. Typically, the DNS servers store mapping information related to domain names such as IP addresses of various resources. In order to provide a central access point, within a large network such as the internet, specific DNS servers known as root-level DNS servers contain a directory of those DNS servers that are registered as authoritative for each domain name.

In one embodiment of the present system, the authoritative DNS servers store the actual domain mapping information for specific domain names. Resolving a domain name typically requires accessing a DNS server to find an IP address of a domain name. If the accessed DNS server cannot find the IP address of a domain name, the root-level DNS servers are queried to ascertain the IP address of an authoritative DNS servers for that particular domain name. The authoritative DNS server is then accessed to retrieve an IP address for the particular domain name.

To reduce traffic to the root-level DNS servers and the authoritative DNS servers, IP address information for specific domain names is often cached within local DNS servers. To maintain accurate entries, the local DNS servers typically query the root-level DNS servers on a periodic basis.

Although somewhat useful, the current standard domain name serving and naming conventions prevent deployment of many useful names and naming strategies. For example, having a top-level domain name that corresponds to a business name or family name is typically not possible with standard top-level domains.

What is needed are means and methods to augment standard domain name serving with a more flexible arrangement and thereby increase the utility of domain naming and serving. Preferably, such means and methods could be incrementally deployed within a network such as the internet.

### SUMMARY OF THE INVENTION

The means and methods of the present invention have been developed in response to the present state of the art, and in particular, in response to the problems and needs in the art that have not yet been fully solved by currently available domain name serving means and methods. Accordingly, the present invention provides a method, apparatus, and system for serving extended domain names.

In one aspect of the present invention, a method for registering domain names involves receiving a proposed domain name that includes a proposed second-level name and a proposed top-level name, comparing the proposed top-level name with standard top-level domain names, and conducting an extended domain name registration process if the proposed top-level name is not a standard top-level domain name. A non-extended domain name registration process may also be conducted if the proposed top-level name is a standard top-level domain name. In one embodiment, the extended domain name registration process involves updating at least one extended domain name server and the non-extended domain name registration process comprises updating at least one non-extended domain name server. The process of updating may occur directly or via a registration server.

In another aspect of the present invention, a method for adding extended domain name access to a client computer includes automatically changing a DNS server IP address to reference an extended domain name server in order to direct domain name queries to the extended domain name server. The method for adding extended domain name access to a client computer facilitates resolving extended domain names entered on a client computer to IP addresses of resources such as web pages.

In conjunction with automatically changing a domain name server IP address, the present invention facilitates conducting maintenance operations related to domain name serving on the client computer. In one embodiment, the maintenance operations include providing status information, updating an executable, updating a domain name server IP address, and restoring the domain name server IP address to a previous value. The ability to conduct maintenance operations improves the quality and reliability of the domain name serving within an intra-network or inter-network. For example, the ability to update a DNS server IP address on a client facilitates shifting access to other DNS servers in the event of network congestion or system failures.

In another aspect of the invention, a server for serving domain names includes a domain name database containing IP addresses of resources corresponding to various domain names, an update module that responds to automatic update requests, and a query module configured to receive a domain name request from a requester, search the database for a corresponding IP address, and return the corresponding IP address to the requester. The aforementioned server supports more than 1000 top-level domains names and is not restricted to current standard top-level domain names.

In another aspect of the present invention, an apparatus for accessing extended domain name servers includes a client computer 110 configured to direct domain names queries to a domain name server capable of supporting more than 1000 top-level domain names such as an extended domain name server. In one embodiment, the aforementioned apparatus facilitates conducting maintenance operations related to domain name serving such as updating status information, updating an executable, updating a domain name server IP address, and restoring the domain name server IP address to a previous value.

The present invention increases the flexibility and usefulness of domain naming and domain name serving. The various aspects of the present invention facilitate resolving extended domain names to IP addresses of resources such as web pages. The present invention also facilitates incrementally upgrading an intra-network or inter-network with extended name serving capabilities. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram illustrating a prior art DNS network in accordance with the present invention;

FIG. 2 is a block diagram illustrating one embodiment of an extended DNS network of the present invention;

FIG. 3 is a flow chart illustrating one embodiment of a domain name registration method of the present invention;

FIG. 4 is a text-based diagram illustrating example domain names in accordance with the present invention;

FIG. 5 is a block diagram illustrating one embodiment of an extended DNS system of the present invention;

FIG. 6 is a flow chart illustrating one embodiment of a DNS extension method of the present invention; and

FIG. 7 is a flow chart illustrating one embodiment of a DNS maintenance method of the present invention.

### DETAILED DESCRIPTION OF THE INVENTION

Many of the functional units described in this specification have been labeled as modules, in order to more particularly emphasize their implementation independence. For example, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module of executable code could be a single instruction, or many instructions, and may even be distributed over several different code segments, among different programs, and across several memory devices.

Modules may also be implemented in hardware as electronic circuits comprising custom VLSI circuitry, off-the-shelf semiconductors such as logic chips, transistors, or other discrete components. A module may also be implemented in programmable hardware devices such as field programmable gate arrays, programmable array logic, programmable logic devices or the like.

Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

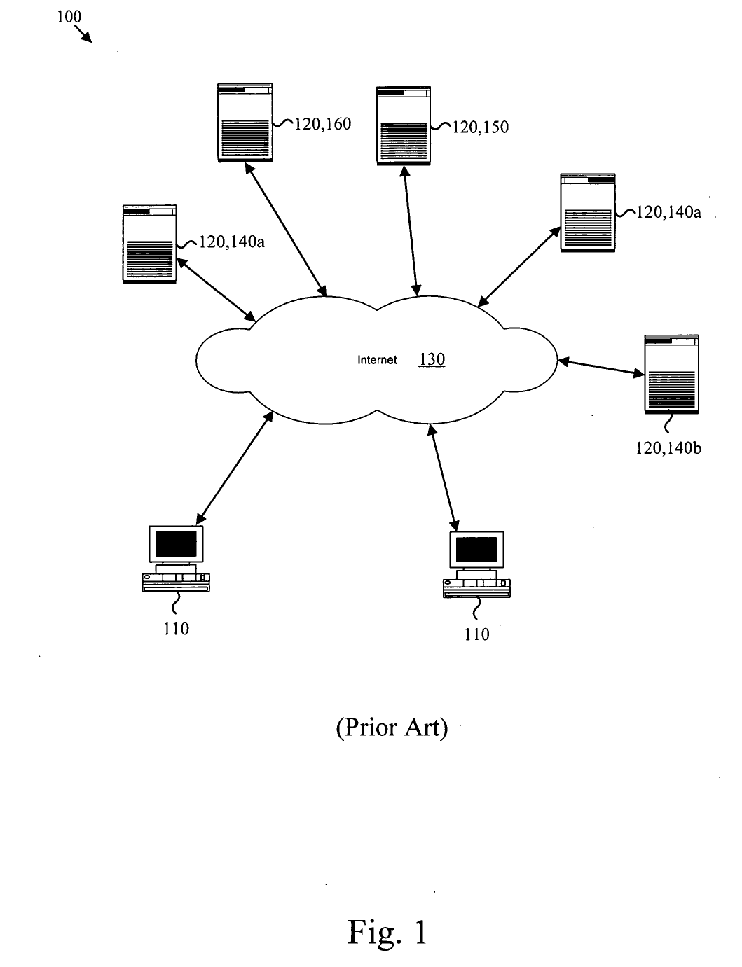

Referring to FIG. 1, a prior art DNS network 100 includes clients 110, and servers 120 interconnected via a network 130 such as the internet. Typically, the servers 120 serve web pages and other information to the clients 110. The servers 120 may include DNS servers 140, and root-level DNS servers 150, and registration servers 160. The various elements of the DNS network 100 facilitate access to resources such as web pages using names rather than numeric IP addresses.

Typically, some of the DNS servers 140 are designated as authoritarian DNS servers 140a, while others are non-authoritarian DNS servers 140b. The root-level DNS servers 150 typically contain a database of authoritarian DNS servers 140a associated with registered domain names. The authoritative DNS servers 140a store the actual domain mapping information for specific domain names.

Requests to resolve domain names to IP addresses are directed from the client 110 to a DNS server 140. If the IP address of the resource specified by the domain name is not known, the DNS server 140 may query the root-level DNS server 150 for an IP address of an authoritative DNS server 140a associated with the domain name. The authoritative DNS server 140a associated with the domain name may then be queried for an IP address of the resource corresponding to the particular domain name.

The mapping information stored within the DNS servers 140 may be data that is cached from accessing authoritative DNS servers 140a. Caching reduces the processing and communications load on the root-level DNS servers 150 and increases the performance of the network 130. Preferably, the cached data is updated and pruned in a manner such that the DNS servers 140 accurately represent the most current information available. In one embodiment, the DNS servers 140 are updated at regular intervals.

Typically, the domain names accepted and stored within the root-level DNS servers 150 are restricted to certain standard top-level domains. For example, ICAAN approved top-level domain names include the names .com, net, .org, .biz, and the like. Although somewhat useful, the structure imposed by standard top-level domain names prevents deployment of many useful names and naming strategies. For example, having a top-level domain name corresponding to a business name or family name is typically not possible with standard top-level domains. What is needed are means and methods to augment standard domain name serving with a more flexible arrangement and thereby increase the utility of domain naming.

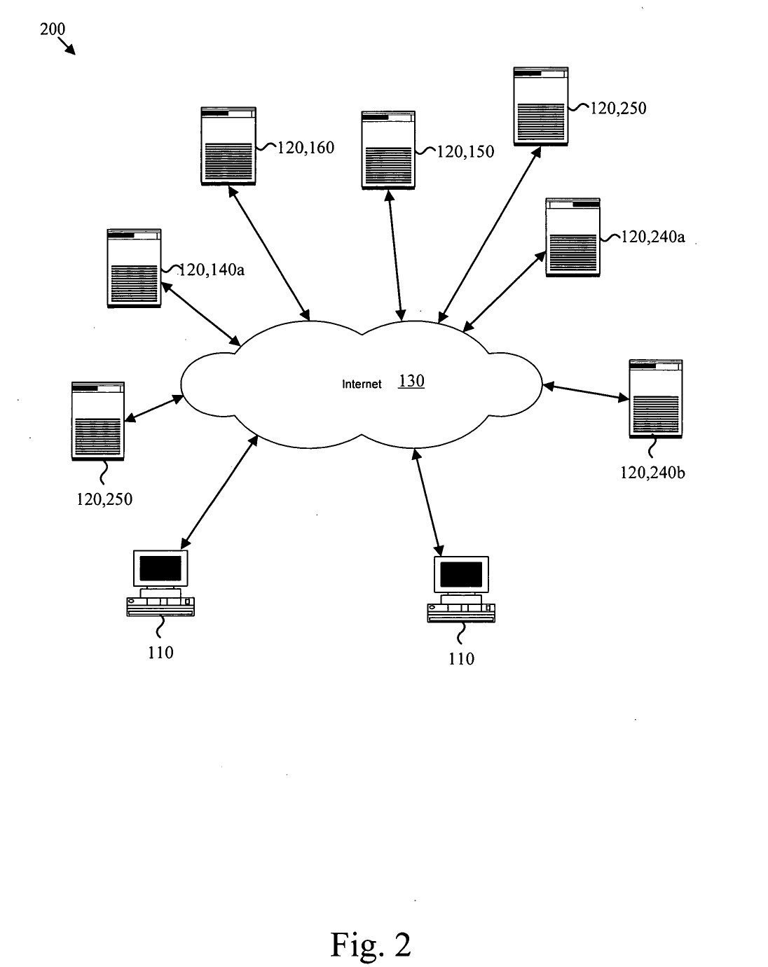

FIG. 2 is a block diagram illustrating one embodiment of an extended DNS network 200 of the present invention. The extended DNS network 200 facilitates more flexible domain name serving than prior art DNS networks such as the DNS network 100. The depicted DNS network 200 augments or replaces portions of the DNS network 100 or similar network with one or more extended DNS servers 240 in order to facilitate more flexible domain name serving to the clients 110. In the depicted embodiment, the extended DNS network 200 also includes a registration server 250 configured to facilitate registration of extended domain names.

The extended DNS servers 240 provide extend domain name serving to those clients 110 which are configured to access the extended DNS servers 240. In addition to caching information for standard domain names, the extended DNS servers 240 contain information for extended domain names—i.e. domain names that do not fit within the structure imposed by standard domain naming conventions. For purposes of network robustness, selected DNS servers 240 may be designated as masters (not shown) while other DNS servers 240 may be designated as slaves (not shown) that are configured to backup a specific master.

In one embodiment, one or more of the extended DNS servers 240 are designated as authoritarian extended DNS servers 240a, while the remaining extended DNS servers 240 may be designated as non-authoritarian extended DNS servers 240b. The authoritarian extended DNS servers 240a function as authoritarian sources of information for extended domain names. In one embodiment, at least one authoritarian extended DNS server 240a also functions as a root-level DNS server 150.

The flexibility offered by the extended DNS servers 240 permits gradual deployment of extended domain naming within a network such as an intra-network or inter-network while maintaining compatibility with the root-level DNS servers 150 and the clients 110. Individual clients 110 may be configured to reference the extended DNS servers 240 instead of the DNS servers 140 without disruption of service. Likewise, the present invention facilitates configuring individual DNS servers 140 as extended DNS servers 240 with little or no downtime.

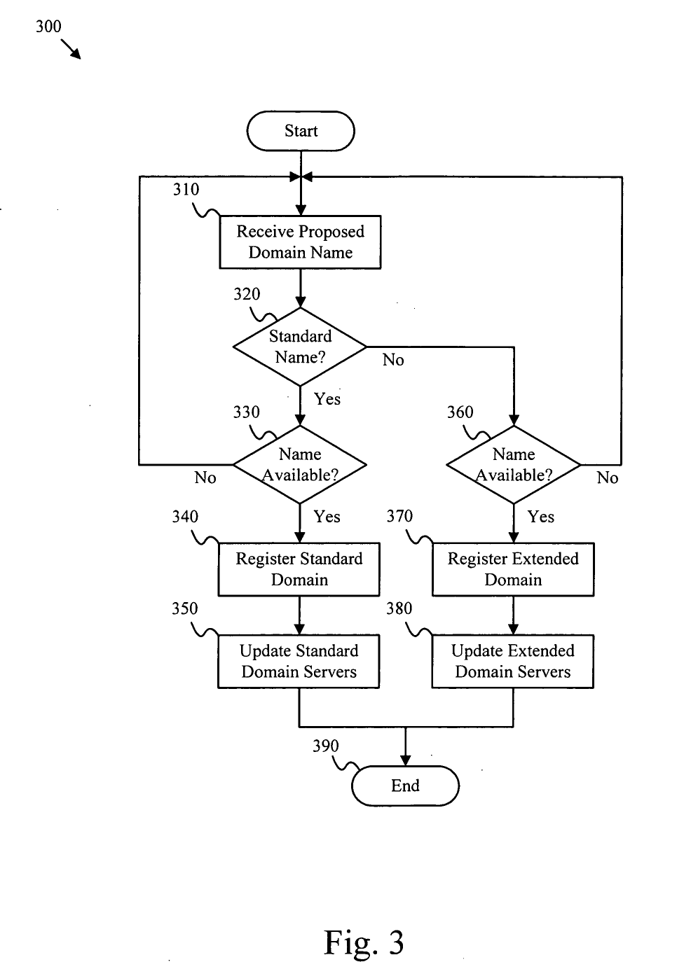

FIG. 3 is a flow chart illustrating one embodiment of a domain name registration method 300 of the present invention. The domain name registration method 300 may be conducted in conjunction with a client 110, and a server 120 such as a web page server. The domain name registration method 300 facilitates registration of both standard and extended domain names.

The domain name registration method 300 includes a receive proposed name step 310, a standard name test 320, a standard name available test 330, a register standard domain name step 340, an update standard DNS servers step 350, an extended name available test 360, a register extended domain name step 370, and an update extended DNS servers step 380.

As depicted, the standard name test 320 ascertains whether a proposed domain name conforms to standard naming conventions. If so, the domain name registration method 300 proceeds to the standard name available test 330. If the proposed domain name does not conform to standard naming conventions, the method proceeds to the extended name available test 360.

The standard name available test 330 ascertains whether the proposed domain name is available. If the proposed name is available, the domain name registration method 300 proceeds to a register standard domain name step 340. In one embodiment, the register standard domain step 340 includes collecting personal and demographic information concerning a registrant, and placing that information within a database.

The update standard DNS servers step 350 updates the authoritative DNS servers for the domain name with mapping information and the like for the newly registered domain name and thorough various channels updates a non-extended registration database with the new domain name. Upon completion of the update standard DNS servers step 350, the domain name registration method 300 ends 390.

The extended name available test 360 ascertains whether the proposed extended domain name is available. If the domain name is available, the method proceeds to the register extended domain name step 370. In one embodiment, the register extended domain step 370 includes collecting the same information that is collected in the register standard domain step 340.

In certain embodiments, the update extended DNS servers step 380 updates the authoritative extended DNS servers 240a via the registration server 250 with mapping information and the like for the newly registered domain name. The non-authoritarian extended DNS servers 240b may also be updated or notified that the authoritarian extended DNS servers 240a have been updated. Upon completion of the update extended DNS servers step 380, the domain name registration method 300 ends 390.

As mentioned previously, in certain embodiments, one or more of the authoritarian extended domain servers 240a may also function as a root-level DNS servers 150. In those embodiments, the update extended DNS servers step 380 may be conducted in response to registering new extended domain names or modification of the IP address associated with existing extended domain names.

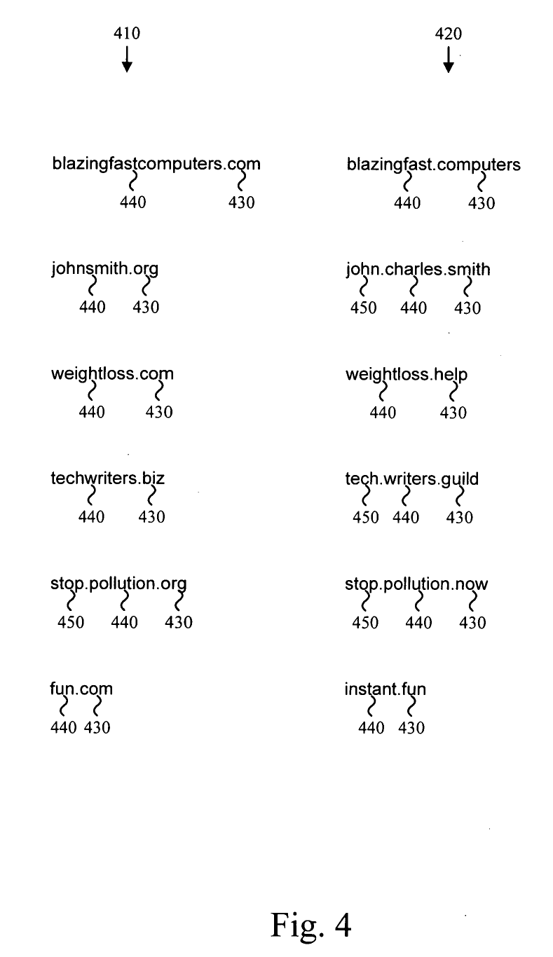

FIG. 4 is a text-base diagram illustrating example domain names in accordance with the present invention. Examples of standard domain names 410 and extended domain names 420 are shown. The depicted standard domain names 410 and extended domain names 420 include a top-level domain name 430, a secondary domain name 440, and in some cases a tertiary domain name 450 and beyond.

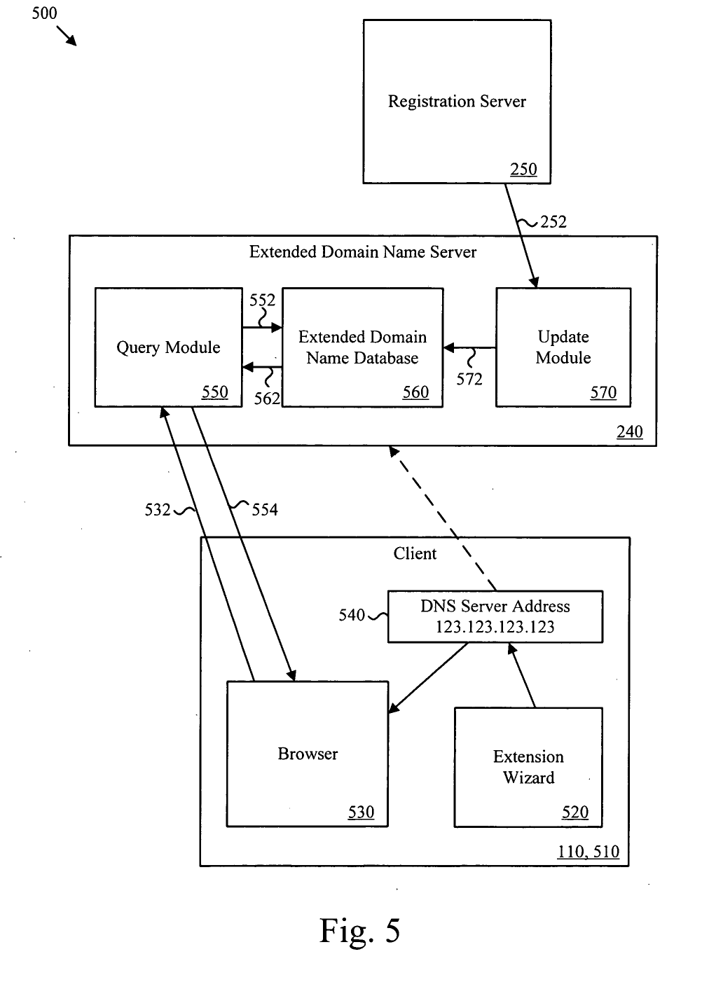

FIG. 5 is a block diagram illustrating one embodiment of an extended DNS system 500 of the present invention. The extended DNS system 500 facilitates extended domain naming within an intra-network or inter-network such as the extended DNS network 200. The extended DNS system 500 includes an extended client 510, and an extended DNS server 240. In the depicted embodiment, the extended DNS system 500 also includes the registration server 250.

The depicted extended client 510 includes an extension wizard 520, a browser 530, and a DNS server address 540. The depicted extended domain name server 240 includes a DNS query module 550, and an extended DNS database 560. The extension wizard 520 is typically downloaded from a web site and executed at the request of a user.

In one embodiment, the extension wizard 520 saves the previous IP address stored within the DNS server address 540. The DNS server address 540 may be a system level setting that is accessible to multiple applications. As depicted, the extension wizard 520 changes the DNS server address 540 to a value corresponding with an extended DNS server such as the depicted extended DNS server 240.

In certain embodiments, the extension wizard 520 may be configured to conduct maintenance operations related to domain name serving. For example, in one embodiment, the extension wizard 520 is configured to display status information regarding the DNS network 200, update the DNS server address 540 in response to an update request, receive executable updates, and the like. The ability to conduct maintenance operations improves the quality and reliability of the extended DNS system 500 and the extended DNS network 200. For example, the ability to update the DNS server address 540 facilitates shifting access to other DNS servers in the event of network congestion or system failures.

The browser 530 references the DNS server address 540 when conducting a DNS query 532 in order to translate a domain name of interest to a corresponding IP address. As depicted, the value stored in the DNS server address 540 corresponds to an IP address assigned to the extended DNS server 240 and facilitates directing the DNS query 532 to the extended DNS server 240.

In response to the DNS query 532, the query module 550 accesses the extended DNS database 560 by providing a domain name 552. In response to reception of the domain name 552, the DNS database 560 searches for a matching record. If successful, a domain IP address 562 is returned to the query module 550 which in turn packages the IP address 562 within a query response 554. Upon reception of the query response, the browser 530 uses the IP address 562 in order to access a web page or similar resource corresponding to the domain name referenced in the query.

The depicted extended DNS server 240 also includes an update module 570. The update module 570 provides update information 572 to the extended DNS database 560. In certain embodiments, the update information 572 is retrieved from the registration server 250 at regular intervals as an update epoch 252.

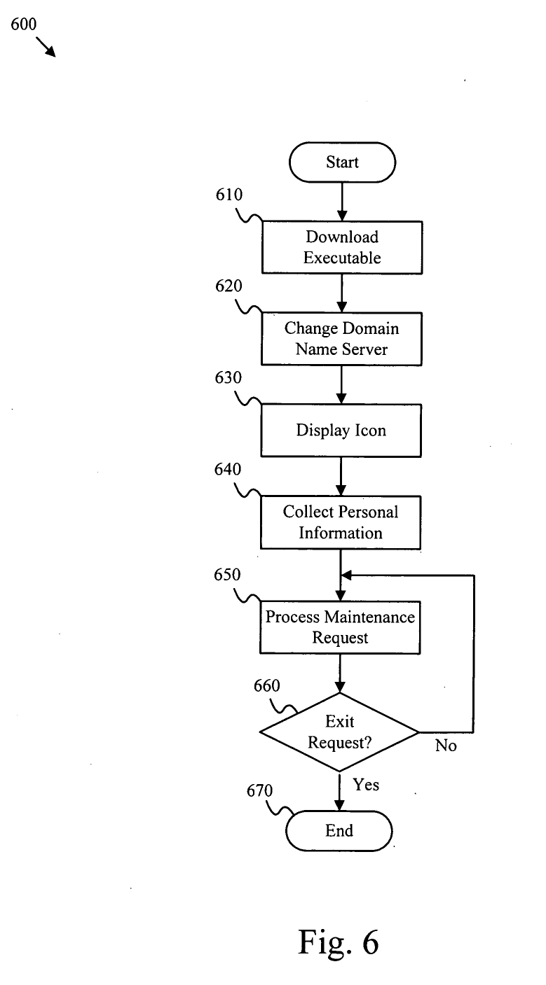

FIG. 6 is a flow chart illustrating one embodiment of a DNS extension method 600 of the present invention. The DNS extension method 600 may be conducted in conjunction with a client 110 in order to convert the client 110 into an extended client 510. The DNS extension method 600 provides extended domain name access capabilities to clients within an intra-network such as an enterprise network or inter-network such as the internet.

The depicted DNS extension method 600 includes a receive executable step 610, a change DNS server step 620, a display icon step 630, a collect personal information step 640, a process maintenance request 650, and an exit test 660. The DNS extension method 600 may be conducted in conjunction with the extension wizard 520 and need not be restricted to the various depicted steps in that some of the depicted steps are optional.

The receive executable step 610 receives an executable image from a web page or other source and commences immediate or deferred execution of that image which in one embodiment is the extension wizard 520. The change DNS server step 620 changes the name server referenced by the client to a name server capable of supporting more than 1000 top-level domain names such as the extended DNS server 240. The display icon step 630 displays an icon (not shown) indicating the status of extended DNS access for the client. In one embodiment, the icon is displayed within the system tray. Selected embodiments of the DNS extension method 600 include the collect personal information step 640. The collect personal information step 640 may be used to direct information of personal interest including promotional information and advertisements to a client.

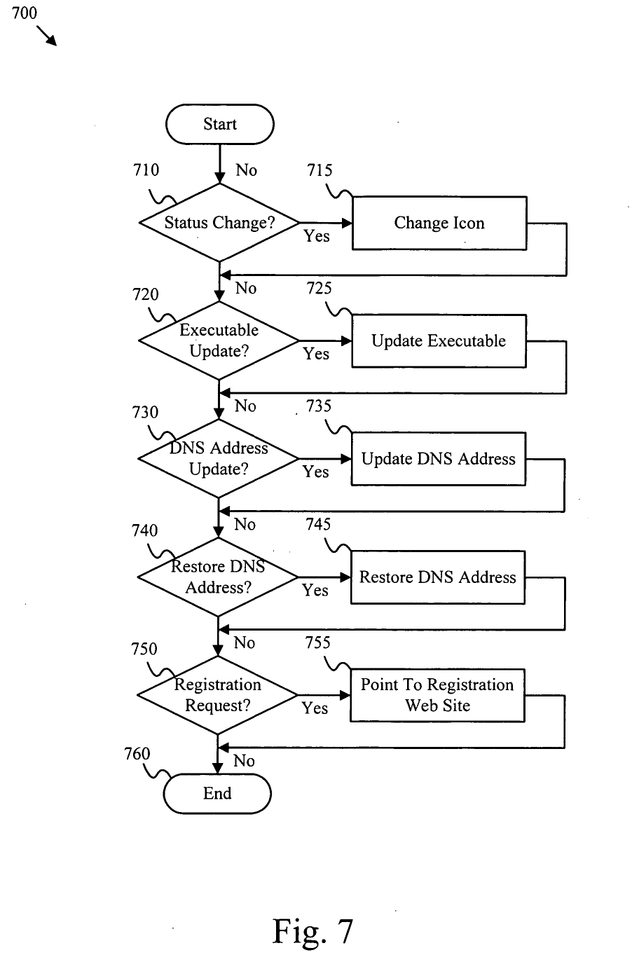

The process maintenance request step 650 conducts requested maintenance operations requested by the client or selected components of the DNS network 200. One embodiment of the a process maintenance request step 650 will be described in more detail in conjunction with FIG. 7. The depicted DNS extension method 600 continues processing maintenance requests until an exit request is received. In response to an exit request, the DNS extension method ends 670.

FIG. 7 is a flow chart illustrating one embodiment of a DNS maintenance method 700 of the present invention. The client maintenance method 700 conducts maintenance operations in response to maintenance requests. Conducting maintenance operations improves the reliability of domain name serving.

Certain embodiments of the DNS extension method 700 include the status change test 710 and the change icon step 715. The status change test 710 ascertains whether the status of extended DNS access for the client has changed. If the status of extended DNS access has changed, the method 700 conducts the change icon step 715 previous to the next step in the depicted polling loop.

Certain embodiments of the DNS extension method 700 include the executable update test 720 and the update executable step 725. The executable update test 720 ascertains whether an executable update is available. If an executable update is available, the method 700 updates the executable via the update executable step 725. In one embodiment, the update executable step 725 entails downloading a self-extracting executable from a designated web site. Upon completion of the executable update test 720 and the update executable step 725 the depicted method 700 continues executing the depicted polling loop.

Certain embodiments of the DNS extension method 700 include the DNS address update test 730 and the update DNS address step 735. The DNS address update test 730 ascertains whether a request to change the DNS address has been received from an authoritative source. If a request has been received, the method 700 conducts the update DNS address step 735.

Certain embodiments of the DNS extension method 700 include the restore DNS address test 740 and the restore DNS address step 735. The restore DNS address test 740 ascertains whether a request to restore the DNS address to a previous value has been received from a user or an authoritative source. If a request has been received, the method 700 conducts the restore DNS address step 735.

Certain embodiments of the DNS extension method 700 include the registration request test 750, and the point to registration site step 755. The registration request test 750 ascertains whether the user has requested access to a registration web site. If access to a registration web site has been requested, the method 700 conducts the point to registration site step 755. In one embodiment, the point registration site step 755 includes changing a URL field within a browser to reference a designated web site. In response to completion of the point registration site step 755 the depicted method 700 ends 760.

The tests 710, 720, 730, 740, and 750 are shown as sequential tests in a polling loop which result in the conditional execution of steps 715, 725, 735, 745, and 755. One of skill in the art will appreciate that the conditional execution of steps 715, 725, 735, 745, and 755 may also be event driven. For example, events such as events corresponding to a user selecting a menu option may trigger the execution of steps 715, 725, 735, 745, and 755.

The present invention adds extended domain naming capabilities to a network such as an intra-network or inter-network. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for registering domain names, the method comprising:
receiving a proposed domain name comprising a proposed second-level name and a proposed top-level name;
comparing the proposed top-level name with standard top-level domain names; and
conducting an extended domain name registration process if the proposed top-level name is not a standard top-level domain name.

2. The method of claim 1, wherein the extended domain name registration process comprises updating at least one extended domain name server.

3. The method of claim 1, further comprising conducting a non-extended domain name registration process if the proposed top-level name is a standard top-level domain name.

4. The method of claim 3, wherein the non-extended domain name registration process comprises updating at least one non-extended domain name server.

5-31. (canceled)
